(19) United States
(12) Patent Application Publication
(10) Pub. No.: US 2008/0059878 A1
(43) Pub. Date: Mar. 6, 2008

(54) Information processing apparatus, information processing method, program and control method of information processing apparatus

(75) Inventor: Takuya Ootani, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,259

(22) Filed: Jul. 23, 2007

(30) Foreign Application Priority Data
Aug. 31, 2006 (JP) 2006-236857

(51) Int. Cl. G06F 15/00

(52) U.S. Cl. 715/273

(57) ABSTRACT

According to one embodiment, an information processing apparatus includes a data obtaining unit which obtains content data, and display screen generating unit which, based on the content data obtained by the data obtaining unit, generates a content display screen and a functional layout display screen displaying a portion associated with a function in the content display screen.

### CROSS-REFERENCE TO RELATED APPLICATIONS

This application is based upon and claims the benefit of priority from Japanese Patent Application No. 2006-236857, filed Aug. 31, 2006, the entire contents of which are incorporated herein by reference.

### BACKGROUND

1. Field

One embodiment of the invention relates to an information processing apparatus, an information processing method, a program, and a control method of an information processing apparatus which inform a user of a functional layout in a graphical user interface (GUI) screen.

2. Description of the Related Art

When a user operates an information processing apparatus such as a personal computer, the user inputs various instructions to the personal computer via a GUI in many cases. For example, when the user uses the Internet, the user inputs various instructions via a GUI screen of a web browser. Generally, the GUI screen includes images to which functions are arranged, buttons, icons, pull-down menus, etc.

In order to inform the user of available functions, various methods are applied to GUIs. For example, there is a method of underlining a hyperlink text within a GUI screen. In addition, there is a method of sequentially focusing a plurality of portions (e.g., a plurality of buttons) in a GUI screen to which portions functions are arranged, every time a tab key of a keyboard is pressed down. Further, there is a method of changing the shape of a cursor when the cursor is put on a portion in a GUI screen to which a function is arranged.

Additionally, a method has been proposed which, when displaying a window including process items, obtains display image data forming the display window, and displays the display window by associating the obtained image data with descriptions of the respective process items (for example, see Japanese Patent Application KOKAI Publication 2006-12038 (hereinafter referred to as “the Publication No. 2006-12038”)).

However, it is against the HD DVD specifications to apply a method, such as underlining texts, adding operations to be performed at the time when the tab key is pressed down, or changing the shape of the cursor, to a GUI screen (content display screen, etc.) which is displayed, for example, at the time of reproduction of an HD DVD.

In addition, the method described in the Publication No. 2006-12038 intends for identifying the correspondence between the process items (buttons, etc.) and processes to be performed. However, the objects to which functions are arranged within a GUI screen are not limited to those objects (such as buttons) which can be easily recognized by the user.

For example, functions may be arranged to those objects which make the user difficult to recognize at first glance that functions are arranged to the objects. In such a case, it is difficult for the user to recognize the arrangement of the functions in the GUI screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a schematic configuration of an information processing apparatus according to an embodiment of the invention;

FIG. 2 is an exemplary block diagram showing a schematic configuration of an advanced application player of the information processing apparatus shown in FIG. 1;

FIG. 3 is an exemplary schematic diagram for explaining an operation of the information processing apparatus shown in FIG. 1;

FIG. 4 is an exemplary schematic diagram for explaining a functional layout display screen;

FIG. 5 is an exemplary schematic diagram showing an exemplary control panel and an exemplary state where a content display screen and a functional layout display screen are displayed in a display of the information processing apparatus shown in FIG. 1;

FIG. 6 is an exemplary flowchart for explaining a functional layout display method according to one embodiment of the invention; and

FIG. 7 is an exemplary flowchart for explaining a control method of the information processing apparatus shown in FIG. 1 in the case where an instruction is input via the functional layout display screen.

### DETAILED DESCRIPTION

Various embodiments according to the invention will be described hereinafter with reference to the accompanying drawings. In general, according to one embodiment of the invention, an information processing apparatus includes: a data obtaining unit which obtains content data; and a display screen generating unit which, based on the content data obtained by the data obtaining unit, generates a content display screen and a functional layout display screen displaying a portion associated with a function in the content display screen.

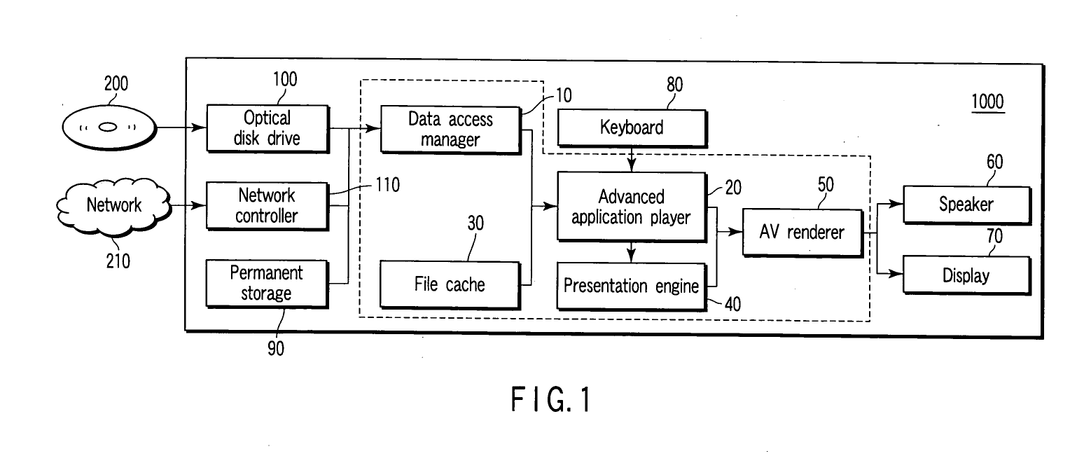

FIG. 1 is an exemplary block diagram showing a schematic configuration of an information processing apparatus according to an embodiment of the invention. For convenience of explanation, it is assumed that the information processing apparatus is a personal computer 1000 including a function of reproducing an HD DVD.

The personal computer 1000 includes a data access manager 10, an advanced application player 20, a file cache 30, a presentation engine 40, an AV renderer 50, a speaker 60, a display 70, a keyboard 80, a permanent storage 90, an optical disk drive 100, a network controller 110, etc.

The optical disk drive 100 is a drive unit which drives a disk 200, which is a recording medium. The network controller 110 performs communication with various external apparatuses, such as a server, via a network 210. The data access manager 10, the advanced application player 20, the presentation engine 40, and the AV renderer 50 are realized by, for example, software to be executed by a CPU in the personal computer 1000.

The data access manager 10 functions as a data obtaining unit which accesses and obtains data (content data) from, for example, the permanent storage 90, the disk 200, or the network 210. The permanent storage 90 may be, for example, a non-volatile memory or a hard disk drive. Examples of the disk 200 include various kinds of optical disks such as a CD, a DVD, and an HD DVD. In addition, examples of the network 210 include a LAN, the Internet, etc.

The advanced application player 20 receives an instruction which is input by the user via the keyboard 80. Additionally, the advanced application player 20 receives data which are supplied from the data access manager 10. Based on the received instruction and data, the advanced application player 20 controls the presentation engine 40 and the AV renderer 50.

The file cache 30 is a buffer memory which caches obtained data, and increases the speed of processing by the advanced application player 20.

The presentation engine 40 receives video data and audio data from the advanced application player 20. Additionally, the presentation engine 40 decodes the video data and the audio data in accordance with control by the advanced application player 20. The decoded video data and audio data are supplied to the AV renderer 50.

The AV renderer 50 outputs the audio data and the video data to the speaker 60 and the display 70, respectively, in accordance with control by the advanced application player 20.

The keyboard 80 functions as an input unit which allows the user to input an instruction to the personal computer 1000. The input unit is not limited to the keyboard 80, and another input unit may be used. Examples of another input unit include a mouse, a remote controller, etc. In addition, the personal computer 1000 may be provided with a control panel 82 (described later with reference to FIG. 5) including various buttons (switches), and the control panel 82 may be used as the input unit. The control panel 82 may be an operation screen displayed by the display 70.

In the present embodiment, the personal computer 1000 is described to include the speaker 60 and the display 70. However, the invention is not limited to such a configuration. The personal computer 1000 may not include the speaker 60 and the display 70, and may be connected to an external speaker and an external display.

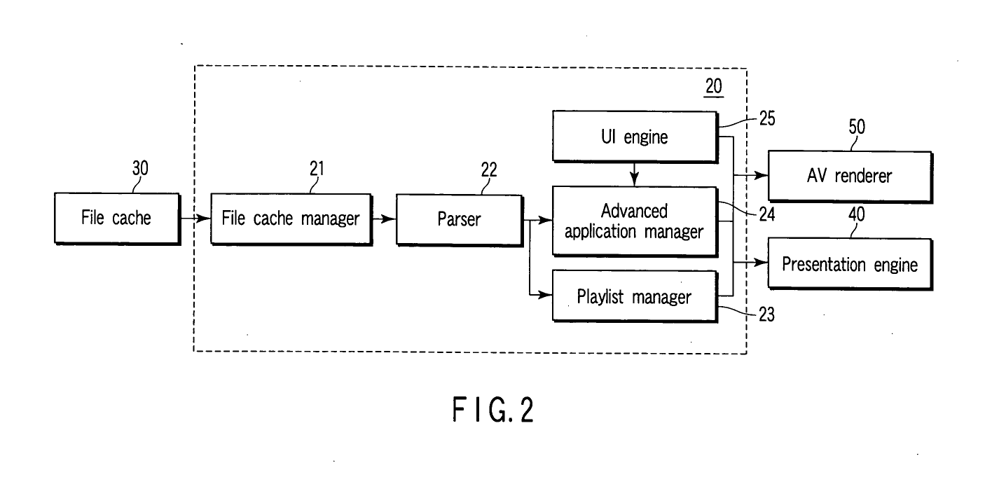

Referring to FIG. 2, a more detailed description is given of the advanced application player 20. FIG. 2 is an exemplary block diagram showing a schematic configuration of the advanced application player 20 provided in the personal computer 1000 shown in FIG. 1.

The advanced application player 20 includes a file cache manager 21, a parser 22, a playlist manager 23, an advanced application manager 24, a user interface (UI) engine 25, etc.

The file cache manager 21 controls the file cache 30, and receives data from the file cache 30. Additionally, the file cache manager 21 supplies data to the parser 22.

The parser 22 performs a parsing process on the data received from the file cache manager 21, and supplies the process result to the playlist manager 23 and the advanced application manager 24.

The playlist manager 23 controls the AV renderer 50 and the presentation engine 40.

The advanced application manager 24 controls the presentation engine 40 and the AV renderer 50.

The UI engine 25 controls the advanced application manager 24 and the AV renderer 50, and processes a user interface.

The advanced application player 20 may be, for example, an HDi engine. Hereinafter, a description is given by assuming that the advanced application player 20 is an HDi engine.

Here, a description is given of the HDi specifications. The HDi is a format which provides interactive functions of an HD DVD, which is also referred to as the next generation DVD. HD DVD content includes video data, audio data, and navigation data. The navigation data includes data for controlling reproduction of content (video data and audio data), and includes a markup file, a script file, and a resource file. In the HD DVD contents, the markup file, the script file, and the resource file are interpreted, and navigation is displayed in a content display screen. The content display screen is a screen which displays moving images and the like obtained by decoding the video data. Various objects (e.g., a graphics image, a text, etc.) used as navigation are displayed on the moving images of the content display screen.

When the navigation is displayed during reproduction of video and audio, the various objects used as the navigation are rendered in front surface of video (moving image). The markup file is, for example, an XML file and corresponds to an HTML file of a web page. The markup file includes descriptions related to an image and a text. The script file is, for example, an ECMAScript file and corresponds to a JavaScript® of a web page. The script file includes descriptions related to processes with respect to an instruction which is input by the user and a system event which occurs internally. A content provider can allocate an arbitrary function with respect to each object by describing codes for carrying out various functions within the script file. The resource file may be video, audio, image, font and data files. The HDi specifications define navigation functions realized by the markup file and the script file.

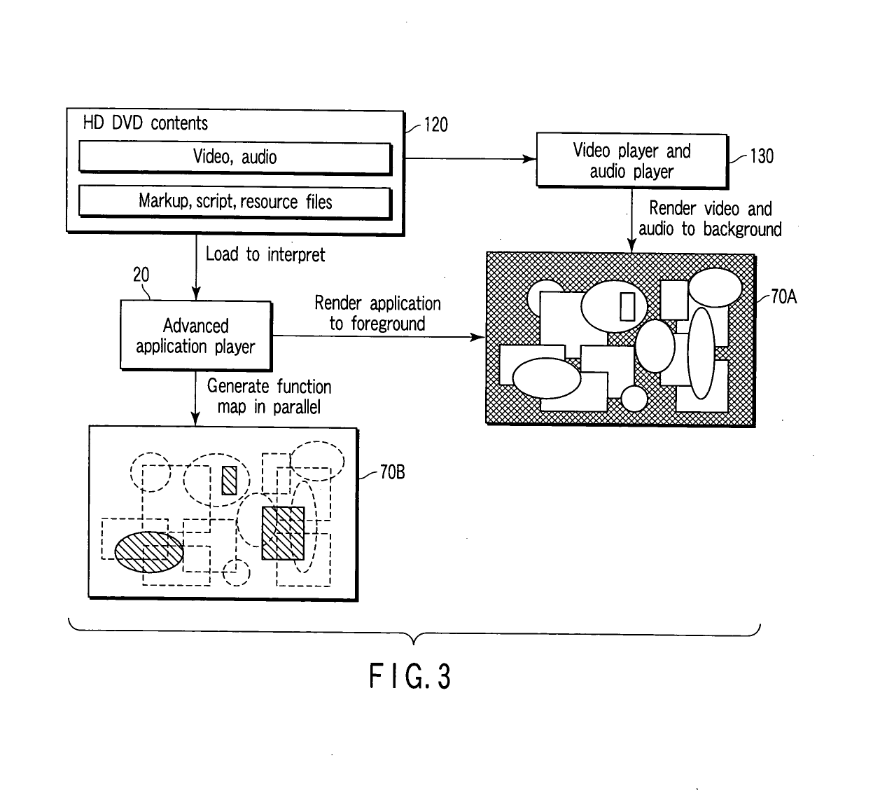

Referring to FIG. 3, a description is given of an operation of the personal computer 1000 including the advanced application player (HDi engine) 20. FIG. 3 is an exemplary schematic diagram for explaining an operation of the personal computer 1000 shown in FIG. 1.

FIG. 3 shows an HD DVD content 120, the advanced application player 20, a video player and audio player 130, a content display screen (main window) 70A, and a functional layout display screen (sub-window) 70B.

The HD DVD content 120 is obtained by the data access manager 10 from the permanent storage 90, the disk 200, or the network 210 shown in FIG. 1. The HD DVD content 120 includes video data, audio data, a markup file, a script file, and a resource file. As mentioned above, the markup file, the script file, and the resource file form navigation data. The resource file includes, for example, images and the like corresponding to each object.

The video player and audio player 130 decodes the video data, the audio data, etc. included in the HD DVD content 120.

The advanced application player (HDi engine) 20 functions as a display screen generating unit which generates the content display screen 70A. The advanced application player (HDi engine) 20 performs a process for generating the content display screen 70A in combination with the presentation engine 40 and the AV renderer 50 shown in FIG. 1. The video data decoded by the video player and audio player 130 is displayed in the content display screen 70A. Various objects used as the navigation are also displayed in the content display screen 70A by the advanced application player (HDi engine) 20.

Further, the advanced application player (HDi engine) 20 also generates the functional layout display screen 70B. Specifically, the advanced application player (HDi engine) 20 interprets the navigation data included in the HD DVD content 120, i.e., the mark up file and the script file, by the parser 22 (see FIG. 2), thereby displaying the various objects in the content display screen 70A and generating the functional layout display screen 70B at the same time. The content display screen 70A and the functional layout display screen 70B are GUI screens displayed in the display 70 shown in FIG. 1. In the display 70, the functional layout display screen 70B may be displayed in front of the content display screen 70A. Of course, the functional layout display screen 70B may be displayed such that the functional layout display screen 70B does not overlap with the content display screen 70A. Further, the functional layout display screen 70B may not be generated concurrently with the content display screen 70A.

It should be noted that the “functional layout display screen” refers to a screen briefly displaying those portions (portions associated with certain functions) to which functions are arranged in the content display screen.

Various functions may be arranged in the content display screen 70A, which is formed by interpreting the markup file and the script file. For example, a function of opening a new menu may be arranged to a certain portion of the content display screen 70A, and the function may be performed when the certain portion of the content display screen 70A is selected (e.g., clicked). Additionally, a function of starting reproduction of video may be arranged to another portion of the content display screen 70A, and the function may be performed when the portion is selected. However, those objects (images, etc.) corresponding to menus, buttons, etc. in the content display screen 70A are provided by the content provider of the content. That is, there is a possibility that the objects to which functions are arranged in the content display screen 70A may not be the objects which are familiar to the user in a Windows® environment. Hence, in some cases, it is difficult for the user to identify which portions of the content display screen 70A include functions (to identify which portions of the content display screen 70A the functions are allocated to).

However, as mentioned above, in the HD DVD specifications, those processes such as underlining texts, adding operations to be performed at the time when the tab key is pressed down, and changing the shape of the cursor are allowed to providers and not to a reproducing side (e.g., the personal computer 1000).

Thus, the personal computer 1000 according to one embodiment of the invention generates and displays the above-mentioned functional layout display screen 70B, thereby allowing the user to easily identify the portions of the content display screen 70A to which available functions are allocated, more specifically, the portions to which objects with functions are arranged.

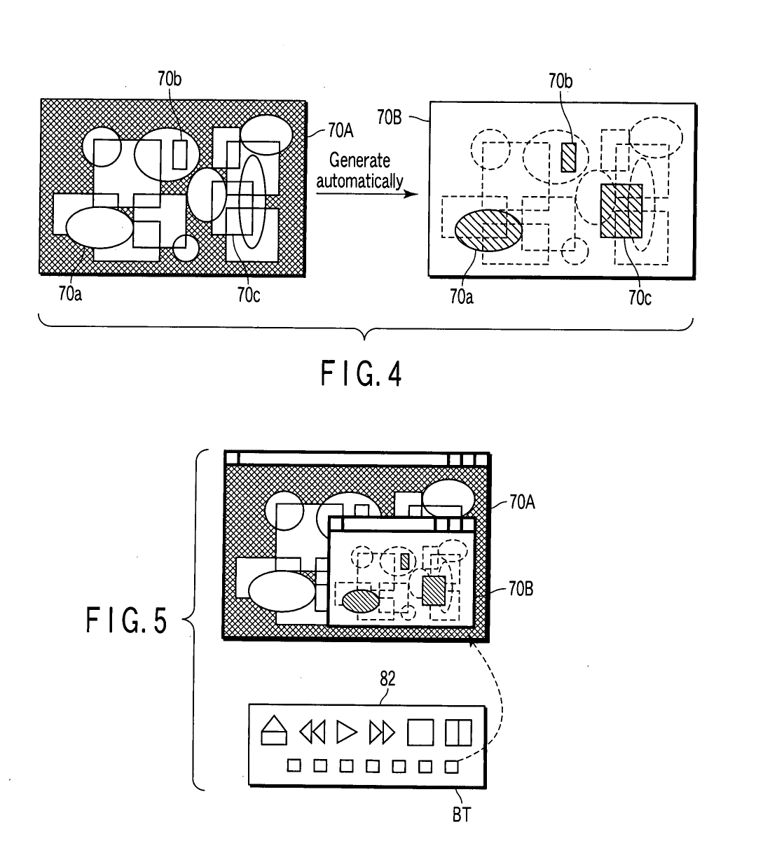

Referring to FIG. 4, a more detailed description is given of the functional layout display screen 70B. FIG. 4 is an exemplary schematic diagram for explaining the functional layout display screen 70B. The content display screen 70A is shown in the left side of FIG. 4, and the functional layout display screen 70B is shown in the right side of FIG. 4.

Various objects (images, characters) are displayed in the content display screen 70A. In FIG. 4, such images are represented by various graphics such as a circle, an oval, a square, and a rectangle. However, the images are not limited to such graphics. In addition, the hatched graphics 70a, 70b and 70c represent images (objects) to which functions are allocated, i.e., images which can be selected by the user by using, for example, the keyboard 80 (see FIG. 1).

The functional layout display screen 70B is generated by the HDi engine 20 based on the content display screen 70A. The functional layout display screen 70B displays the images 70a, 70b and 70c to which the functions are allocated (in other words, the images 70a, 70b and 70c associated with certain functions) as hatched images. Hence, the user can easily identify the portions of the content display screen 70A to which the functions are allocated (portions associated with certain functions), i.e., the portions where the objects to which functions are allocated exist. Hereinafter, those portions to which functions are allocated in the content display screen 70A are referred to as “function-allocated portions”.

FIG. 4 shows a case where a plurality of function-allocated portions (the images 70a, 70b and 70c) exist. However, the content display screen 70A may include a single function-allocated portion. Additionally, a method of showing the function-allocated portions in the functional layout display screen 70B is not limited to hatching of those portions. For example, the function-allocated portions may be colored. Additionally, only the outlines of the function-allocated portions may be displayed. In addition, the function-allocated portions may be blinked. Further, the portions other than the function-allocated portions may be filled with white color, black color, etc. Any method may be applied to display the function-allocated portions in the functional layout display screen 70B as long as the method allows the user to easily identify the function-allocated portions. In addition, the functional layout display screen 70B shown in FIGS. 3 and 4 displays images other than the function-allocated portions. However, the images other than the function-allocated portions may not be displayed in the functional layout display screen 70B.

Referring to FIG. 5, a description is given of how the content display screen 70A and the functional layout display screen 70B are displayed in the display 70. FIG. 5 is an exemplary schematic diagram showing the control panel 82 and an exemplary state where the content display screen 70A and the functional layout display screen 70B are displayed in the display 70 of the information processing apparatus 1000 shown in FIG. 1.

The functional layout display screen 70B is displayed in the display 70 in accordance with an instruction which is input by the user. For example, the functional layout display screen 70B can be displayed in front of the content display screen 70A in the display 70 with a size smaller than that of the content display screen 70A. An instruction may be input by using not only the keyboard 80 (see FIG. 1) but also a mouse, a remote controller, various buttons included in the control panel 82, etc. For example, as shown in FIG. 5, in the case where the control panel 82 is provided with a button BT for the user to input an instruction for displaying the functional layout display screen 70B, when the user presses the button BT, the functional layout display screen 70B is displayed in the display 70 (see FIG. 1). It should be noted that the control panel 82 is an operating panel or window provided with buttons (switches) for inputting various instructions, such as record, reproduce, and stop, to the advanced application player 20 of the personal computer 1000.

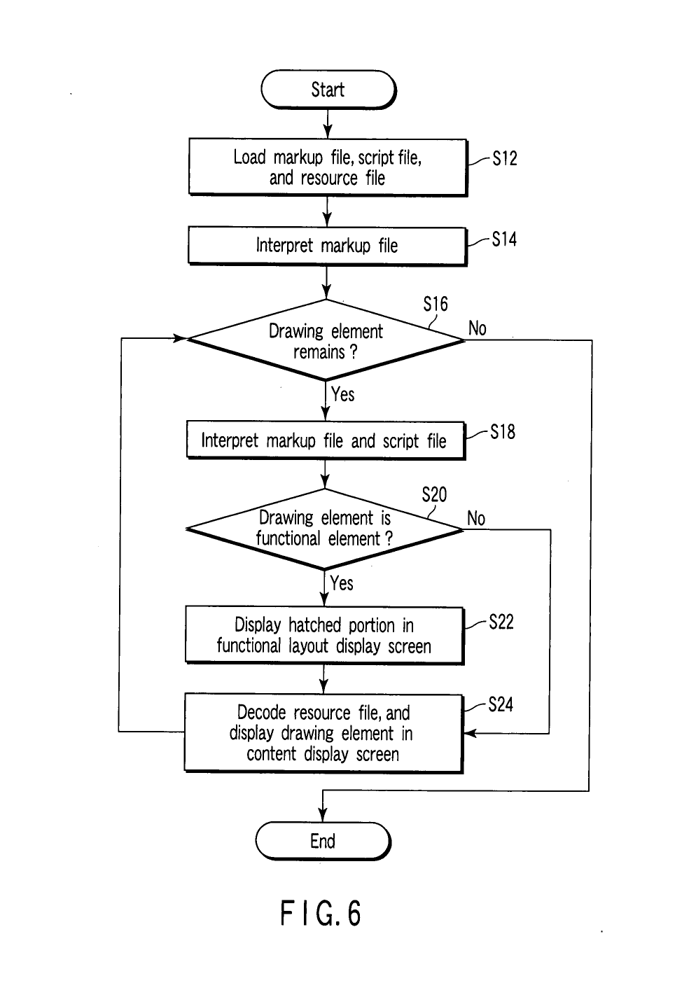

Referring to FIG. 6, a description is given of a method of generating and displaying the functional layout display screen 70B (hereinafter referred to as “the functional layout display method”). FIG. 6 is an exemplary flowchart for explaining the functional layout display method according to one embodiment of the invention. The functional layout display method may be applied to the information processing apparatus (personal computer) 1000 shown in FIG. 1. More specifically, the functional layout display method may be applied to the advanced application player (HDi engine) 20. Hereinafter, for convenience of explanation, a description is given of an exemplary case where the functional layout display method is applied to the advanced application player 20. Each block of the flowchart shown in FIG. 6 is performed by the advanced application player (HDi engine) 20.

The markup file, the script file, and the resource file are loaded by the advanced application player 20 from, for example, the disk 200 (block S12). The markup file including descriptions related to arrangement of various objects (images, texts) is interpreted (block S14). By interpreting the markup file, information related to drawing elements (objects) is obtained, and whether the drawing elements remain is determined (block S16).

In the case where no drawing element remains (NO in block S16), the process ends. On the other hand, in the case where a drawing element remains (YES in block S16), the markup file and the script file are interpreted (block S18). Referring to the markup file and the script file, it is determined whether the remaining drawing element is a functional element, i.e., whether a function is allocated to an object to be displayed (block S20).

In the case where the remaining drawing element is not a functional element (NO in block S20), the resource file is decoded, and the drawing element is drawn (displayed) in the content display screen content display screen 70A (block S24).

On the other hand, in the case where the remaining drawing element is a functional element (YES in block S20), the function-allocated portion in the functional layout display screen 70B is displayed as a hatched portion (block S22). As for block S22, as described above, any method may be applied as long as the method allows the user to easily identify the function-allocated portion. The resource file is decoded, and the drawing element is drawn in the content display screen 70A (block S24).

After the drawing element is drawn in the content display screen 70A, the process returns to block S16. Blocks S16 through S24 are repeated until no drawing element remains.

In the flowchart shown in FIG. 6, the process in block S24 is performed after the process in block S22. However, in the case where the drawing element is a functional element (YES in block S20), the processes in blocks S22 and S24 may be performed simultaneously.

In addition, the functional layout display method according to one embodiment of the invention may be realized as a program for causing an information processing apparatus (e.g., the information processing apparatus 1000 shown in FIG. 1) to carry out the functional layout display method. For example, a recording medium such as an optical disk storing the program may be inserted into the information processing apparatus 1000, and the information processing apparatus 1000 may load and carry out the program. Further, the program may be downloaded to the information processing apparatus 1000 via the network 210 such as the Internet.

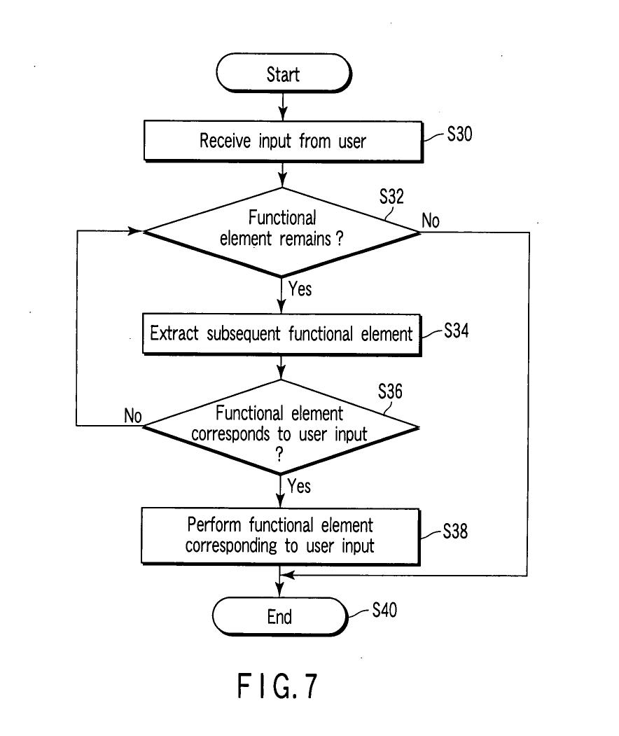

Referring to FIG. 7, a description is given of a method of controlling the information processing apparatus 1000 in the case where an instruction is input by the user via the functional layout display screen 70B. FIG. 7 is an exemplary flowchart for explaining a control method of the information processing apparatus 1000 in the case where an instruction is input via the functional layout display screen 70B. Each block of the flowchart shown in FIG. 7 may be performed by the advanced application player (HDi engine) 20.

For example, each graphic in the functional layout display screen 70B is associated with a functional element of a corresponding object in the content display screen 70A by the advanced application player (HDi engine) 20.

An instruction from the user which is input via the functional layout display screen 70B (hereinafter referred to as “the user input”) is received (block S30). Upon reception of the user input, a process is performed which searches the markup file for a functional element corresponding to a graphic in the functional layout display screen 70B specified by the user input.

First, it is determined whether or not an unchecked functional element remains in the markup file (block S32).

In the case where the unchecked element does not remain (NO in block S32), the process ends (block S40). On the other hand, in the case where the unchecked functional element remains (YES in block S32), the subsequent unchecked functional element is extracted (block S34). It is determined whether or not the extracted functional element is a functional element corresponding to the user input (block S36).

In the case where the extracted functional element is not the functional element corresponding to the user input (NO in block S36), the process returns to block S32. Blocks S32 through S36 are repeated until the functional element corresponding to the user input is extracted. On the other hand, in the case where the extracted functional element is the functional element corresponding to the user input (YES in block S36), the function corresponding to the functional element is performed (block S38), and the process ends (block S40).

The above description is given of the case where the information processing apparatus 1000 is a personal computer. However, the information processing apparatus 1000 is not limited to the personal computer. For example, the information processing apparatus 1000 may be an HD DVD recording/reproducing apparatus.

Additionally, the above description is given of the case where the processing object is the HD DVD content data. However, the invention can be applied to content data other than the HD DVD content data. For example, the invention can be applied to a clickable map used in a web page. The clickable map refers to a function of setting a hyperlink to an image (area) in a web page. For example, by using such a clickable map, a function can be realized which displays a web page of a specific restaurant when an image for the restaurant is clicked in a web page showing a map. In a web page using the clickable map, in some cases, it is difficult for the user to identify clickable portions, in other words, the function-allocated portions. For example, in the case where the web page includes a lot of images/texts, and the clickable map is applied to only a part of the images/texts, it may be difficult for the user to identify such images/texts. By applying an embodiment of the invention to such a case and providing the functional layout display screen, it is possible for the user to easily identify portions in the web page to which portions available functions are allocated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a data obtaining unit which obtains content data; and
a display screen generating unit which, based on the content data obtained by the data obtaining unit, generates a content display screen and a functional layout display screen displaying a portion associated with a function in the content display screen.

2. The information processing apparatus according to claim 1, wherein the content display screen is a display screen displaying a moving image and an object, the object being arranged on the moving image, the function being allocated to the object, and
the functional layout display screen is a display screen displaying the portion on which the object is arranged in the content display screen.

3. The information processing apparatus according to claim 1, further comprising an input unit which allows input of an instruction for displaying the functional layout display screen.

4. The information processing apparatus according to claim 1, further comprising a display unit which displays the content display screen and the functional layout display screen.

5. The information processing apparatus according to claim 1, wherein the portion associated with the function is displayed by a method selected from a group consisting of hatching, blinking, coloring, displaying of only an outline, and filling of a portion other than the portion associated with the function in the functional layout display screen.

6. A computer program product configured to store program instructions for execution on a computer enabling the computer to perform:
obtaining content data; and
generating, based on the obtained content data, a content display screen and a functional layout display screen displaying a portion associated with a function in the content display screen.

7. The computer program product according to claim 6, wherein the content display screen displays a moving image and an object, the object being arranged on the moving image, the function being allocated to the object, and
the functional layout display screen displays the portion on which the object is arranged in the content display screen.

8. The computer program product according to claim 6, further enabling the computer to perform:
inputting an instruction for displaying the functional layout display screen.

9. The computer program product according to claim 6, further enabling the computer to perform:
displaying the content display screen and the functional layout display screen.

10. The computer program product according to claim 6, wherein the portion associated with the function is displayed by a method selected from a group consisting of hatching, blinking, coloring, displaying of only an outline the portion, and filling of a portion other than the portion associated with the function in the functional layout display screen.

11. A control method to be applied to an information processing apparatus, the control method comprising:
obtaining content data;
generating and displaying, based on the obtained content data, a content display screen and a functional layout display screen displaying a portion associated with a function in the content display screen;
receiving an instruction which is input via the functional layout display screen; and
causing the information processing apparatus to perform the function corresponding to the instruction.

12. The control method according to claim 11, wherein the content display screen displays a moving image and an object, the object being arranged on the moving image, the function being allocated to the object, and
the functional layout display screen displays the portion on which the object is arranged in the content display screen.

13. The control method according to claim 11, wherein the portion associated with the function is displayed by a method selected from a group consisting of hatching, blinking, coloring, displaying of only an outline the portion, and filling of a portion other than the portion associated with the function in the functional layout display screen.
